(19) United States
(12) Patent Application Publication
(10) Pub. No.: US 2021/0099837 A1
(43) Pub. Date: Apr. 1, 2021

(54) INTELLIGENT CONTROL SYSTEM FOR MONITORING COMPUTING DEVICES AND PHYSICAL ASSETS WITHIN A PREMISES AND FOR FACILITATING RELATED TRANSACTIONS

(71) Applicant: Smarter Building Technologies Alliance, Inc., Long Beach, CA (US)

(72) Inventors: Benjamin Buchanan, Long Beach, CA (US); Tony Garcia, Rocklin, CA (US); Shane Acernese, Drums, PA (US); Rich Hanlon, Georgetown, MA (US); Chris Loeser, North Olmsted, OH (US); Kevin Martin, Gloucester, MA (US)

(21) Appl. No.: 16/584,729

(22) Filed: Sep. 26, 2019

(51) Int. Cl. H04W 4/029; H04W 4/33; G07C 5/00

(52) U.S. Cl. CPC H04W 4/029; G07C 5/008; H04W 4/33

(57) ABSTRACT

The disclosed embodiments provide an intelligent control system to monitor the presence, physical location, and identity of computing devices and wireless transceivers within a defined space. That information is routed to a server that facilitates transactions involving physical assets in which the wireless transceivers are installed among persons who are operating the computing devices.

### FIELD OF THE DISCLOSURE

The disclosed embodiments provide an intelligent control system to monitor the presence, physical location, and identity of computing devices and wireless transceivers within a defined space. That information is routed to a server that facilitates transactions involving physical assets in which the wireless transceivers are installed, where the transactions are among persons who are operating the computing devices.

### BACKGROUND

Car dealerships are prevalent in the prior art. FIG. 1 depicts a prior art car dealership operating within premises 100. Premises 100 is a physical site with ascertainable boundaries. In the particular scenario depicted in FIG. 1, premises 100 is occupied by customers 101a and 101b, sales persons 102a and 102b, and vehicles 103a, 103b, and 103c. This depiction is merely exemplary, and it will be understood that premises 100 can be occupied at any given moment by any number of customers 101, sales persons 102, and vehicles 103.

In the prior art, when a customer, such as customer 101a, enters premises 100, he or she is approached by one or more sales persons 102, usually because the customer is seen by a sales person as the customer enters the front door of a showroom located within premises 100. Once a sales person, such as sales person 102a, interacts with customer 101a, customer 101a may ask to physically inspect and test drive one or more vehicles 103, such as vehicle 103a. Sales person 102a often will then walk throughout premises 100 looking for vehicle 103a, which can be a time-consuming and frustrating process for both customer 101a and sales person 102a. Customer 101a might very well leave premises 100 at that point. To complicate matters further, sales person 102a may not know that customer 101a has left the premises and may spend fruitless minutes searching for customer 101a after sales person 102a is able to locate vehicle 103a.

Other inefficiencies and frustrations exist in prior art car dealerships. For example, when customer 101a enters premises 100, sales persons 102 will not know if customer 101a has previously visited the car dealership and if customer 101a has already built a relationship with one of the sales persons 102. This may result in numerous sales persons 102 speaking with customer 101a only to find out that customer 101a is looking for a particular sales person, sales person 102a. As another example, vehicles 103 sometimes may be removed from premises 100 altogether, such as in the situation where vehicle 103a is sent to the service department for modifications or maintenance or where vehicle 103a is being test-driven outside of premises 100.

What is needed is a system and method for monitoring the location and identity of each customer, vehicle, and other relevant persons and physical assets within a premises. What is further needed is a system and method for automatically informing a sales person if a particular customer has left the premises or has re-entered the premises.

### BRIEF SUMMARY OF THE INVENTION

The disclosed embodiments provide an intelligent control system to monitor the presence, physical location, and identity of computing devices and wireless transceivers within a defined space. That information is routed to a server that facilitates transactions involving physical assets in which the wireless transceivers are installed among persons who are operating the computing devices.

### BRIEF DESCRIPTION OF THE DRAWINGS

FIG. 1 depicts a premises in which a prior art car dealership is located.

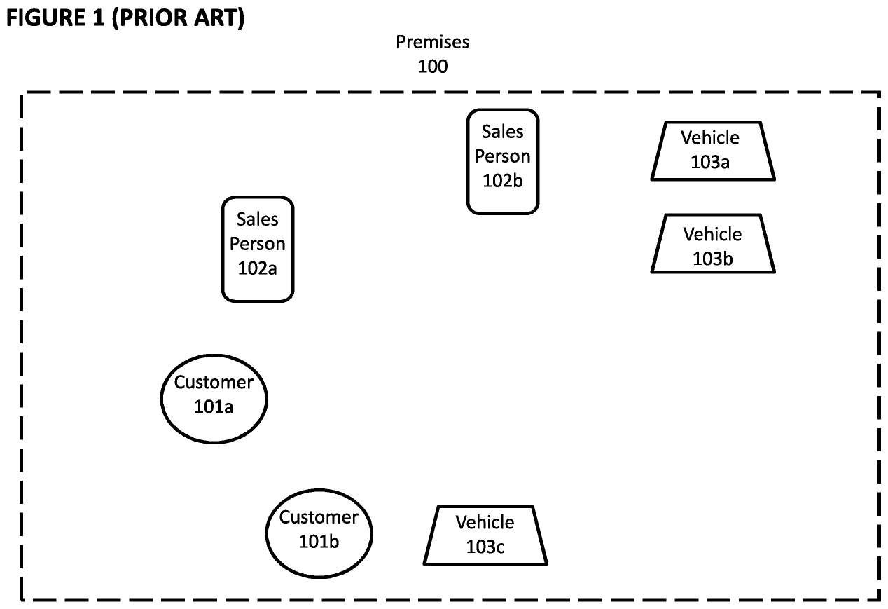

FIG. 2 depicts modules and wireless transceivers installed within a premises.

FIG. 3 depicts aspects of a module.

FIG. 4 depicts an occupancy footprint for the module.

FIG. 5 depicts wireless footprints for the module.

FIG. 6 depicts aspects of a wireless transceiver.

FIG. 7 depicts wireless footprints for the wireless transceiver.

FIG. 8 depicts a prior art client device.

FIG. 9 depicts a client device operated by a customer.

FIG. 10 depicts a client device operated by a sales person.

FIG. 11 depicts a client device operated over the web.

FIG. 12 depicts a server in communication with a gateway and numerous client devices.

FIG. 13 depicts aspects of a server.

FIG. 14 depicts an unknown person entering the premises.

FIG. 15 depicts a computing device operated by the previously unknown person being registered.

FIG. 16 depicts the computing device leaving the premises.

FIG. 17 depicts the computing device re-entering the premises.

FIG. 18 depicts an exemplary graphical display on a client device operated by a sales person.

FIG. 19 depicts another exemplary graphical display on a client device operated by a sales person.

FIG. 20 depicts another exemplary graphical display on a client device operated by a sales person.

FIG. 21 depicts another exemplary graphical display on a client device operated by a sales person.

FIG. 22 depicts another exemplary graphical display on a client device operated by a sales person.

FIG. 23 depicts data structures established by the server for each client device, module, and wireless transceiver.

FIG. 24 depicts a data structure established by the server to monitor the real-time activity of each module.

### DETAILED DESCRIPTION OF PREFERRED EMBODIMENTS

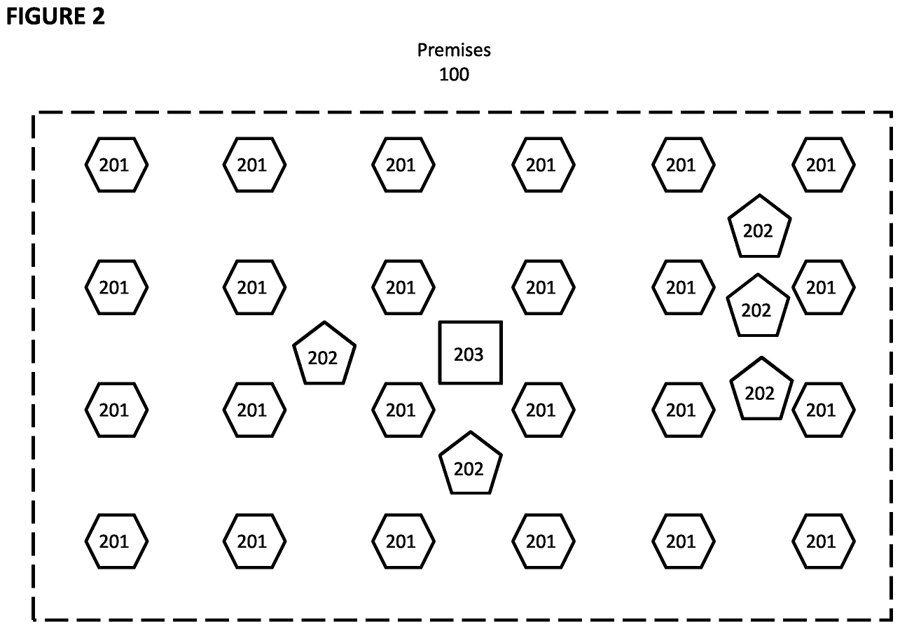

FIG. 2 depicts premises 100 that implements one embodiment of the invention. A plurality of modules 201 are installed throughout premises 100. Wireless transceiver 202 is installed in each vehicle located within premises 100. For example, if the embodiment is used in a car dealership, premises 100 can be a physical location where the car dealership operates, modules 201 can be installed as fixtures throughout premises 100, and a wireless transceiver 202 can be placed on the dashboard of each vehicle. Optionally, wireless transceivers 202 can be used in conjunction with other physical assets as well, such as car keys, dealership test drive license plates, or other physical assets. Gateway 203 is placed within premises 100 as well.

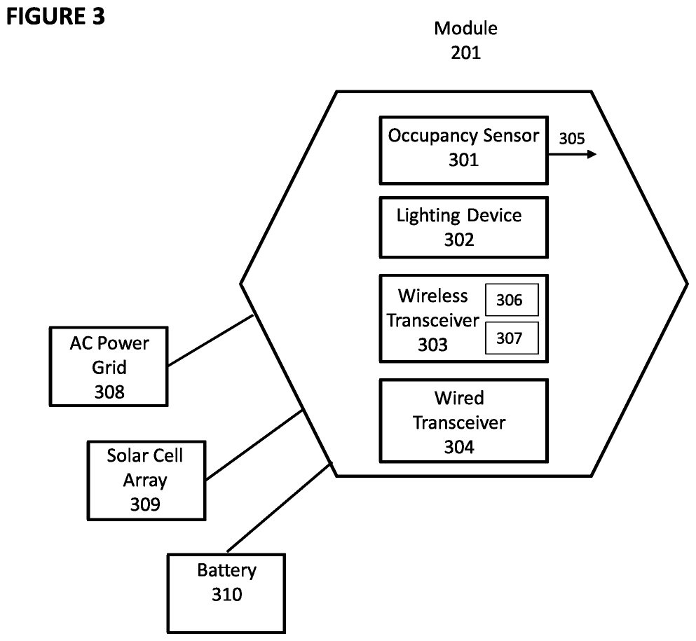

FIG. 3 depicts module 201 in greater detail. Module 201 comprises occupancy sensor 301, lighting device 302, wireless transceiver 303, and optionally, wired transceiver 304.

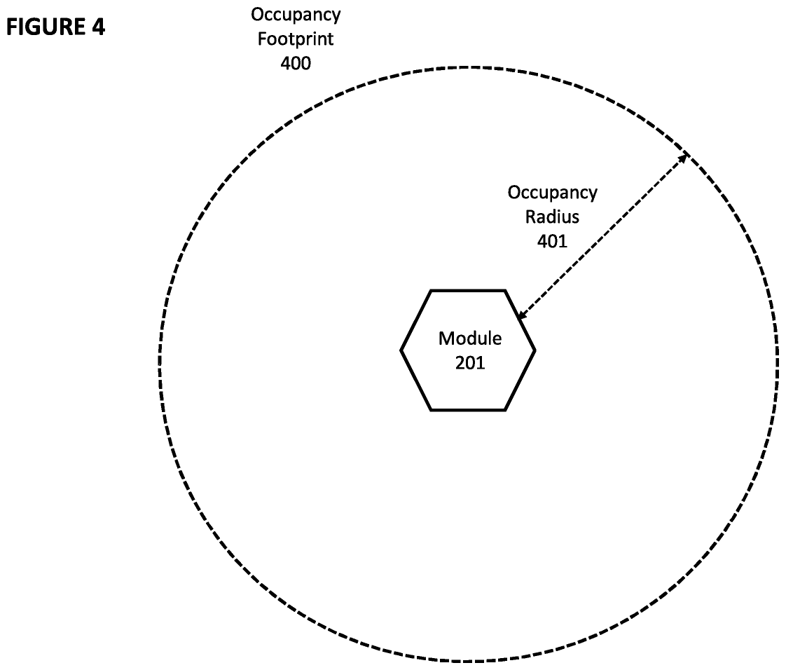

Occupancy sensor 301 is a motion detecting device that can detect the presence of a person within occupancy radius 401 (shown in FIG. 4, where occupancy footprint 400 is the area in which occupancy is detected) using infrared, ultrasonic, microwave, or other technology. Occupancy sensor 301 generates output 305. In one configuration, output 305 is a single-bit digital output, where output 305 is a ‘0’ when no motion is detected and is a ‘1’ when motion is detected, or vice-versa.

Lighting device 302 is a device that emits light, such as an incandescent light bulb fixture, a fluorescent light bulb fixture, or an LED fixture. The presence of lighting device 302 makes the use of module 201 extremely practical, as existing lighting devices in premises 100 can be replaced with module 201. Optionally, module 201 receives its power from existing electrical wiring, such as wiring connected to standard alternating current (AC) power grid 308. Thus, module 201 can be installed in the ceiling of a building and on lamp posts outside of a building in the same manner that traditional lighting fixtures are installed. In another embodiment, module 201 receives its power locally from solar cell array 309, battery 310, or other sources.

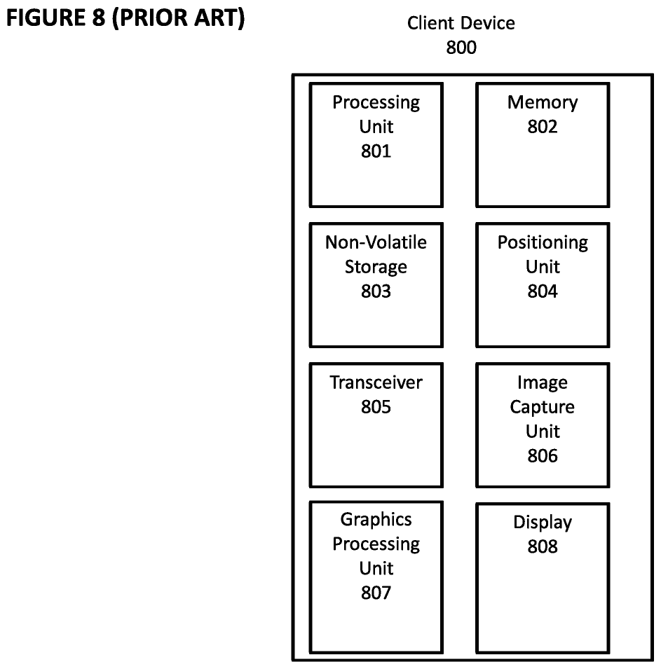

Wireless transceiver 303 is used to communicate with client devices 800 (discussed below with reference to FIG. 8), other modules 201, wireless transceivers 202, and gateway 203 within a certain radius.

Wireless transceiver 303 optionally comprises a plurality of wireless transceiver modules, such as wireless transceiver modules 306 and 307, each of which can engage in wireless communications using the same or a different wireless protocol. For example, wireless transceiver module 306 can engage in a wireless protocol such as the protocols known by the trademarks BLUETOOTH, ZIGBEE, RFID, WIFI, 3G, 4G, 5G, LTE, or other known protocols, and wireless transceiver module 307 can engage in the same or a different one of those protocols.

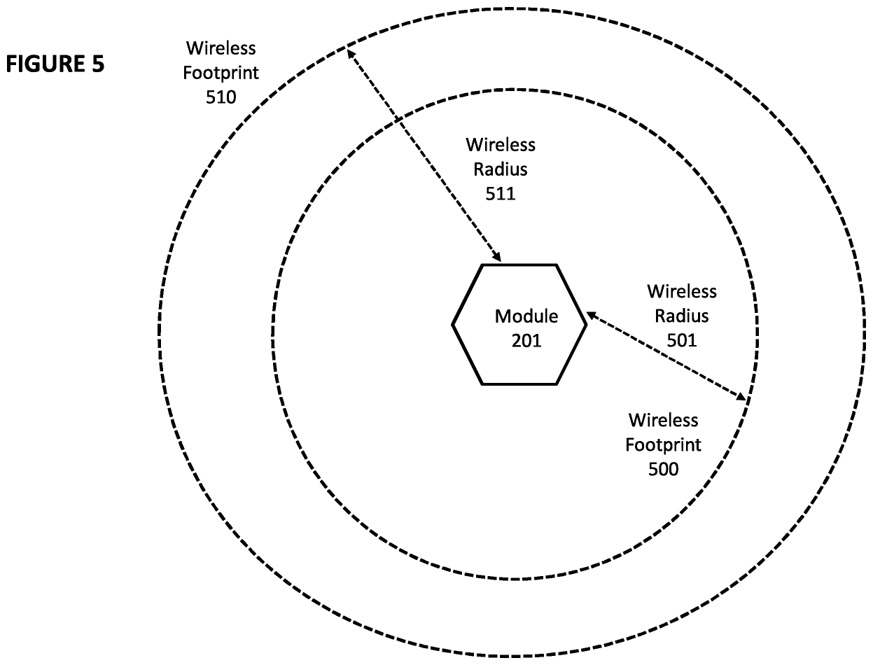

In one embodiment, wireless transceiver module 306 communicates using a first wireless protocol (such as the protocol known by the trademark BLUETOOTH) with devices within radius 501 (shown in FIG. 5, where wireless footprint 500 is the area in which wireless transceiver module 306 can communicate), and wireless transceiver module 307 communicates using a second wireless protocol (such as the protocol known by the trademark WIFI) with gateway 203 within radius 511 (shown in FIG. 5, where wireless footprint 510 is the area in which wireless transceiver module 307 can communicate).

Optionally, wireless transceiver 303 can comprise additional wireless transceiver modules, such as a specialized video transceiver module.

Wired transceiver 304 is optional. When present, wired transceiver 304 can communicate with other modules 201 or with gateway 203 using a wired communication process (such as the protocol known by the trademark ETHERNET).

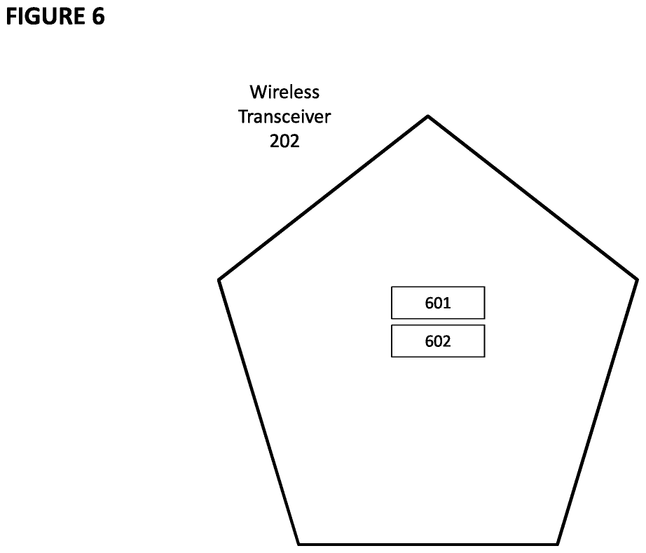

FIG. 6 depicts wireless transceiver 202 in greater detail. Wireless transceiver 202 is used to communicate with client devices 800, modules 201, other wireless transceivers 202, and gateway 203 within a certain radius. Wireless transceiver 202 optionally comprises a plurality of wireless transceiver modules, such as wireless transceiver modules 601 and 602, each of which can engage in wireless communications using the same or a different wireless protocol. For example, wireless transceiver module 601 can engage in a wireless protocol such as the protocols known by the trademarks BLUETOOTH, ZIGBEE, RFID, WIFI, 3G, 4G, 5G, LTE, or other known protocols, and wireless transceiver module 602 can engage in the same or a different one of those protocols.

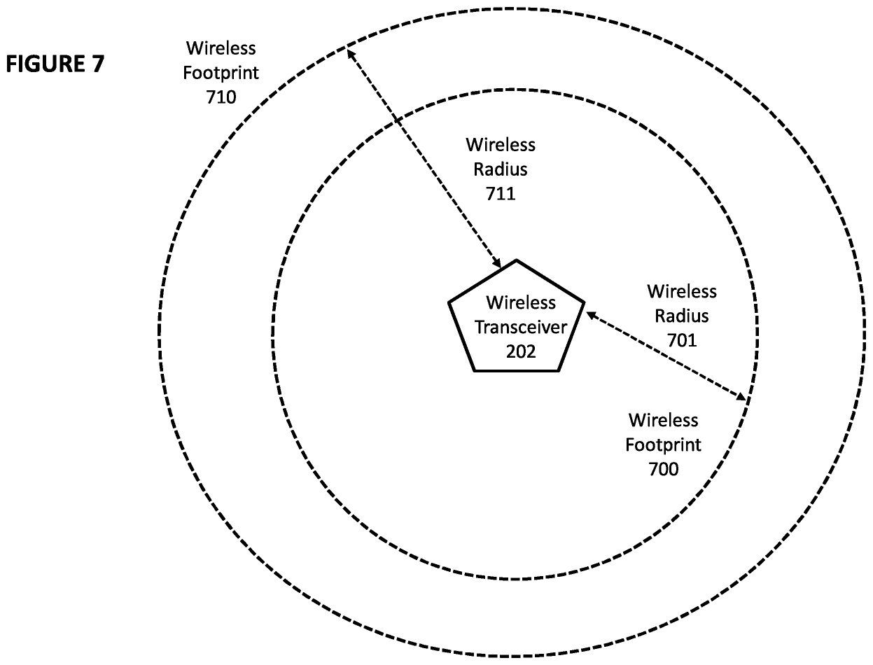

In one embodiment, wireless transceiver module 601 communicates using a first wireless protocol (such as the protocol known by the trademark BLUETOOTH) with devices within radius 701 (shown in FIG. 7, where wireless footprint 700 is the area in which wireless transceiver module 601 can communicate), and wireless transceiver module 602 communicates using a second wireless protocol (such as the protocol known by the trademark WIFI) with gateway 203 within radius 711 (shown in FIG. 7, where wireless footprint 710 is the area in which wireless transceiver module 602 can communicate).

With reference again to FIG. 2, modules 201 ideally will be installed within premises 100 in such a manner that the entirety of premises 100, or substantially the entirety of premises 100, will be covered by one or more wireless footprints 500 of modules 201 and by one or more occupancy footprints 400 of modules 201, thereby eliminating or reducing the presence of any “dead zones” within premises 100 that are not sensed by any occupancy sensor 301 or that are not within wireless range of any wireless transceiver 303.

Gateway 203 itself comprises one or more wireless transceivers and, optionally, one or more wired transceivers, and is capable of establishing a wireless network within premises 100. Gateway 203 also can be coupled to server 1200 (described below) and/or to the Internet.

Gateway 203 will be located in such a manner that it is within wireless footprints 510 and 710 of one or more modules 201 and wireless transceivers 202, such that the modules 201 and wireless transceivers 202 can communicate with gateway 203 in a wireless fashion. Optionally, more than one gateway 203 can be installed within premises 100.

FIG. 8 depicts hardware components of client device 800. These hardware components are known in the prior art. Client device 800 is a computing device that comprises processing unit 801, memory 802, non-volatile storage 803, positioning unit 804, transceiver 805, image capture unit 806, graphics processing unit 807, and display 808. Client device 800 can be a smartphone, notebook computer, tablet, desktop computer, gaming unit, wearable computing device such as a watch or glasses, or any other computing device.

Processing unit 801 optionally comprises a microprocessor with one or more processing cores. Memory 802 optionally comprises DRAM or SRAM volatile memory. Non-volatile storage 803 optionally comprises a hard disk drive or flash memory array. Positioning unit 804 optionally comprises a GPS unit or GNSS unit that communicates with GPS or GNSS satellites to determine latitude and longitude coordinates for client device 100, usually output as latitude data and longitude data. Transceiver 805 comprises one or more of a wired transceiver (such as a network interface compliant with a wired protocol such as that known by the trademark ETHERNET) and a wireless transceiver (such as an interface compliant with a wireless protocol such as those known by the trademarks BLUETOOTH, WIFI, 3G, 4G, 5G, and LTE). Image capture unit 806 optionally comprises one or more standard cameras (as is currently found on most smartphones and notebook computers). Optionally, image capture unit 806 can comprise a camera on one side of client device 800 and another camera on the opposite side of client device 800. Graphics processing unit 807 optionally comprises a controller or processor for generating graphics for display. Display 808 displays the graphics generated by graphics processing unit 807, and optionally comprises a monitor, touchscreen, or other type of display.

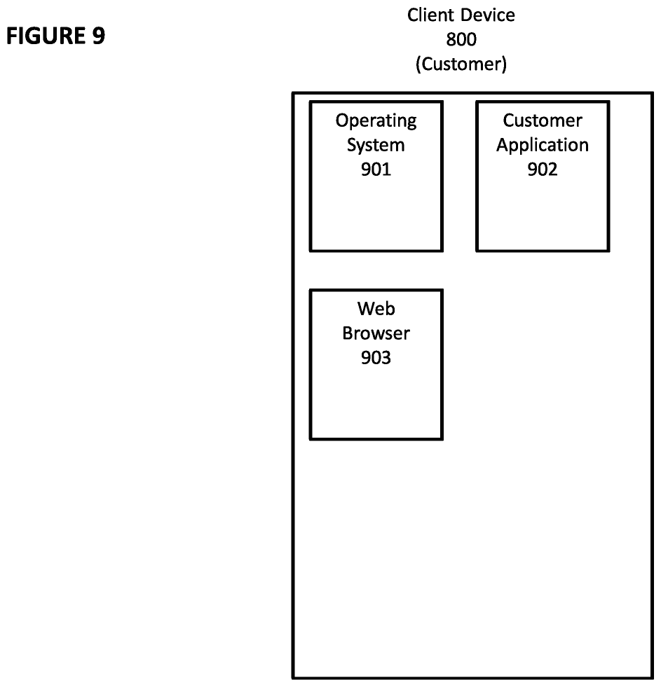

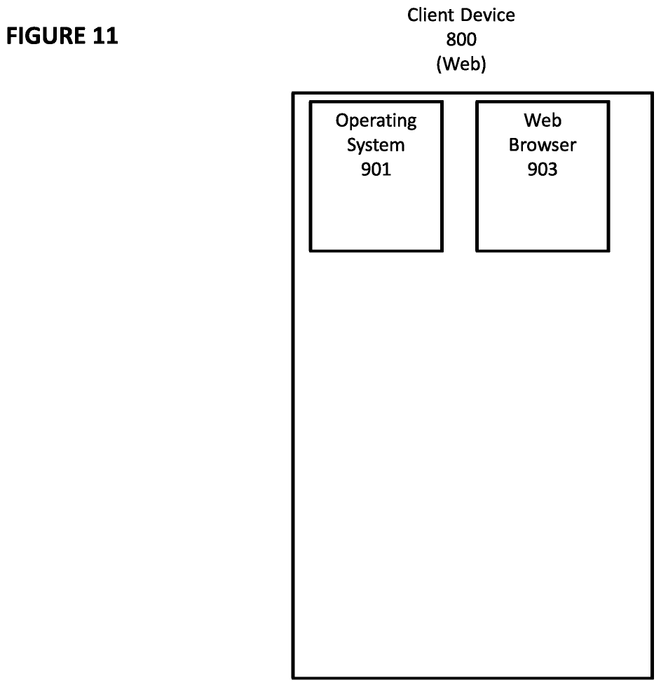

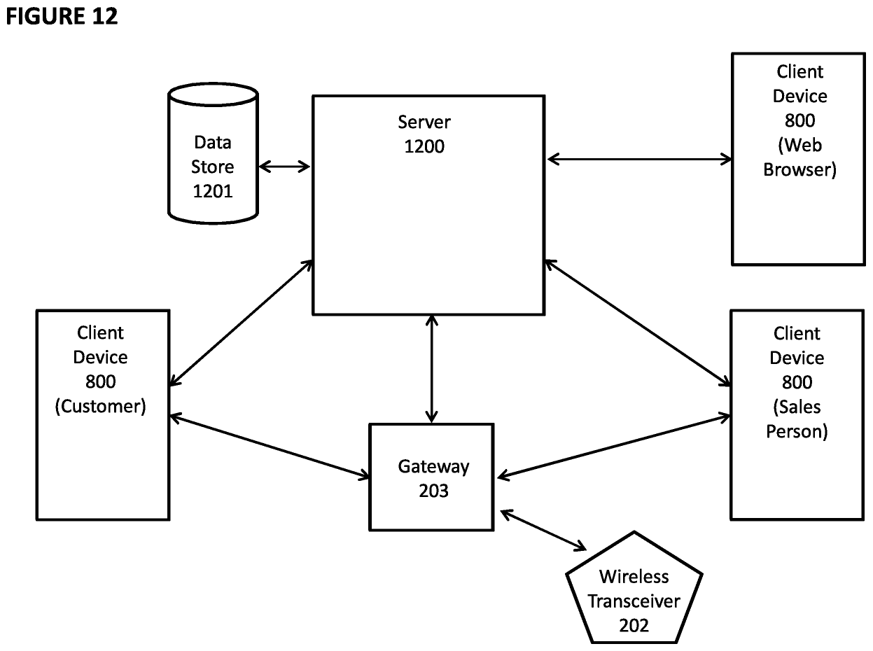

FIG. 9 depicts software components of client device 800 when used for a customer in the embodiments disclosed herein. Client device 800 comprises operating system 901 (such as the operating systems known by the trademarks “WINDOWS,” “LINUX,” “ANDROID,” “IOS,” or others), customer application 902, and web browser 903 (such as the web browsers known by the trademarks “CHROME,” “FIREFOX,” and “INTERNET EXPLORER”). Customer application 902 comprises lines of software code executed by processing unit 801 and/or graphics processing unit 807 to perform the functions described below. For example, client device 800 can be a smartphone sold with the trademark “GALAXY” by Samsung or “IPHONE” by Apple, and customer application 902 can be a downloadable app installed on the smartphone or a browser running code obtained from server 1200 (described below with reference to FIG. 12). Client device 800 also can be a notebook computer, desktop computer, game system, or other computing device, and customer application 902 can be a software application running on client device 800. In the alternative, client device 800 can operate web browser 903 and run code obtained from server 1200, such as by accessing a website or implementing an API. Customer application 902 forms an important component of the inventive aspect of the embodiments described herein, and customer application 902 is not known in the prior art. For convenience, when client device 800 is running customer application 902, it may be referred to herein as “client device 800 (customer).” When client device 800 is running web browser 903, it may be referred to herein as “client device 800 (web browser),” as shown in FIG. 11

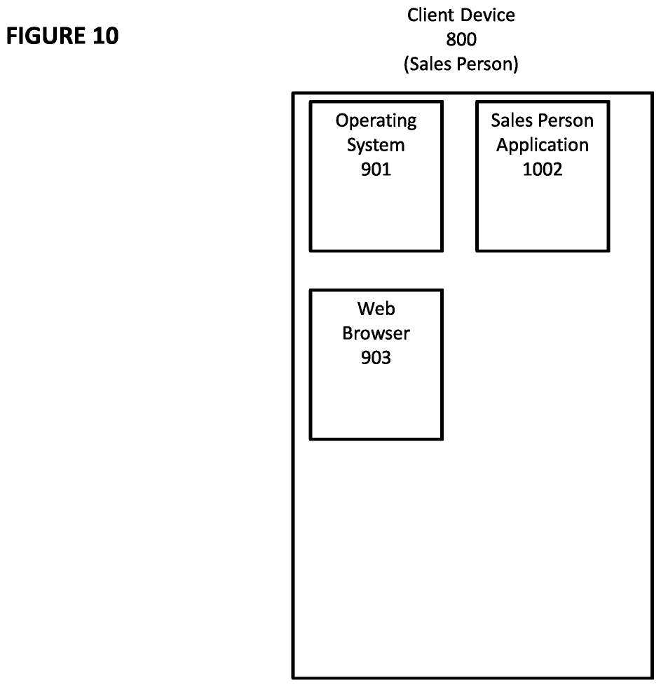

FIG. 10 depicts software components of client device 800 when used for a sales person in the embodiments disclosed herein. Client device 800 comprises operating system 901 and web browser 903 as in FIG. 9 and sales person application 1002. Sales person application 1002 comprises lines of software code executed by processing unit 801 and/or graphics processing unit 807 to perform the functions described below. For example, client device 800 can be a smartphone sold with the trademark “GALAXY” by Samsung or “IPHONE” by Apple, and sales person application 1002 can be a downloadable app installed on the smartphone. Client device 800 also can be a notebook computer, desktop computer, game system, or other computing device, and sales person application 1002 can be a software application running on client device 800. In the alternative, client device 800 can operate web browser 903 and run code obtained from server 1200, such as by accessing a website or implementing an API. Sales person application 1002 forms an important component of the inventive aspect of the embodiments described herein, and sales person application 1002 is not known in the prior art. For convenience, when client device 800 is running sales person application 1002, it may be referred to herein as “client device 800 (sales person)”. The term “client device 800 (sales person)” also can encompass wireless transceiver 202 when it is carried on the body of the sales person, such as in a name badge or attached to a lanyard.

With reference to FIG. 12, exemplary client devices 800 (customer), 800 (sales person), and 800 (web browser) communicate with server 1200, directly and/or indirectly through gateway 203, using transceiver 805 in each device.

Wireless transceiver 202 communicates with server 1200 indirectly through gateway 203. Each wireless transceiver 202 provides the following information to gateway 203, which then sends the information to server 1200:
Device ID;
RSSI;
Transmission power;
Advertising interval;
Telemetry data (temperature, light, accelerometer, battery life); and
AoD—Angle of Delivery

Wireless transceiver 202 also can be configured to store information specific to the asset (such as a vehicle) to which it is associated and can provide the following information to gateway 203, which then sends the information to server 1200:
Images of asset; and
Asset-specific information, such as color, make, model, and sales price

Server 1200 comprises some or all of the same hardware components depicted in FIG. 8 for client devices 800, and for efficiency's sake, those hardware components will not be described again. In addition, server 1200 contains or is coupled to data store 1201, which comprises additional non-volatile storage and can be used to store a database and associated data. Data store 1201 can be contained within server 1200, it can be physically separate from server 1200 but local to server 1200 (e.g., connected by a direct link), or it can be located remotely from server 1200 (e.g., in the cloud). Server 1200 communicates with gateway 203 over a wired or wireless interface. Server 1200 optionally can obtain the following information from gateway 203 through an API or other mechanism:
Proximity approximations for detected beacons (immediate, near, far, or distance estimation);
Distance approximations for detected beacons (must calculate manually);
Any data broadcast from detected beacons (ID, RSSI, telemetry);
Timestamp for when packet from beacon received;
Location and telemetry data can be accessed as a stream through WebSocket/MQTT;
GPS coordinates of gateway;
AoA—Angle of Arrival; and
AoD—Angle of Delivery

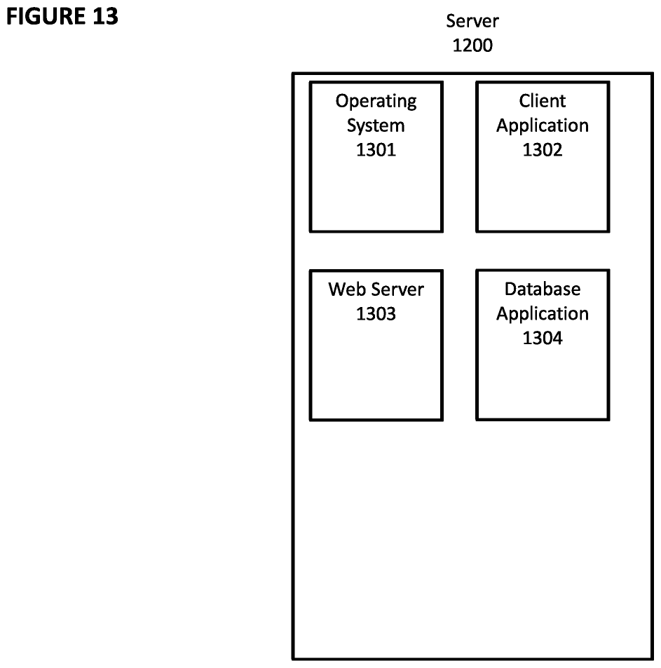

With reference to FIG. 13, server 1200 also comprises software components, such as operating system 1301, (such as the server-side operating systems known by the trademarks “WINDOWS” or “LINUX”), client application 1302, web server 1303 (such as the web server known by the trademark “APACHE”), and database application 1304 (such as a SQL database). Client application 1302 comprises lines of software code executed by processing unit 801 and/or graphics processing unit 807 within server 1200 to perform the functions described below. Client application 1302 is designed to interface specifically with client devices 800 running customer application 902 or sales person application 1002. Client application 1302 forms an important component of the inventive aspect of the embodiments described herein, and client application 1302 is not known in the prior art. Web server 1303 provides web functionality (such as a web site or APIs) that can be accessed by web browser 903 in client device 800. Database application 1304 utilizes data store 1201 to store data.

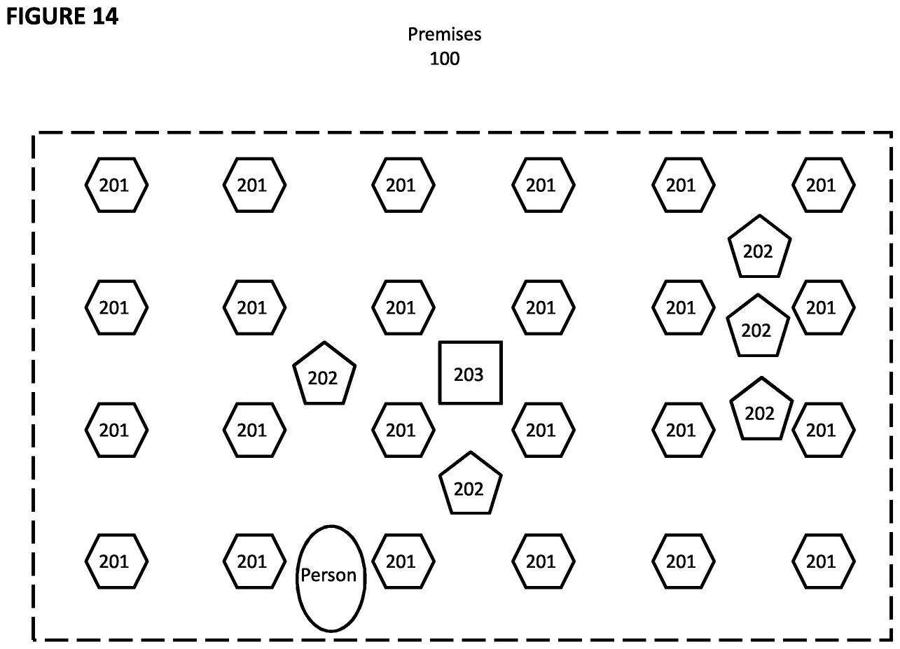

Operation of the embodiments will now be described with reference to FIGS. 14-17.

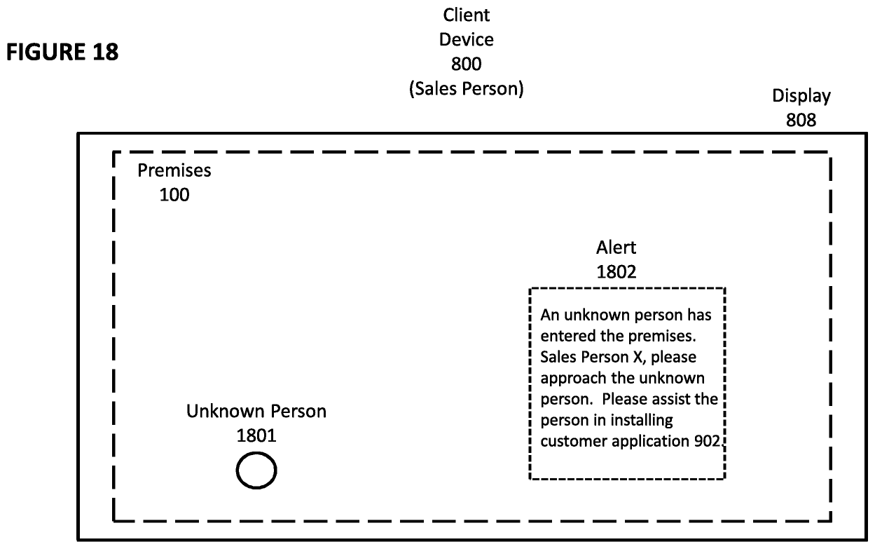

In FIG. 14, a person enters premises 100. For example, the person might be a customer entering a car dealership. When the person enters into occupancy footprint 400 of one of the modules 201, that module will generate output 305, which will be communicated to server 1200 via wireless transceiver 303 or wired transceiver 304 and gateway 203, indicating the presence of a person within occupancy footprint 400. Server 1200 will wait to see if a client device 800 (customer or sales person) is detected on the person by wireless transceiver 303. If no client device 800 is detected, server 1200 will conclude that the person does not have a client device 800, that the person has a client device 800 that is turned off or that has its wireless capability turned off, or that the person has a client device 800 that is not compatible with wireless transceiver 303 or that does not have customer application 902 or sales person application 1002 installed. If no client device 800 is detected, server 1200 optionally can issue an alert or message to cause a sales person to approach the person to assist that person (as described below with reference to FIG. 18).

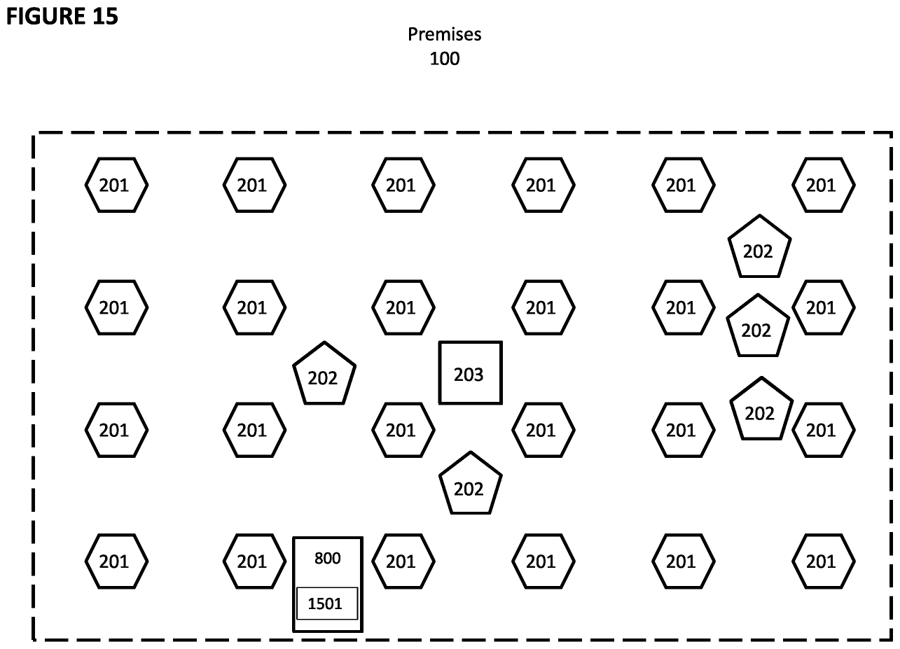

In FIG. 15, client device 800 is detected. If client device 800 already has installed customer application 902, then client device 800 (customer) will be recognized and certain information gathered (as discussed below). If client device 800 has not yet installed customer application 902, then optionally server 1200 can send a notification to client device 800 asking if it wishes to communicate with server 1200 (for example, by asking if it wishes to “pair” with wireless transceiver 303 using a wireless protocol such as BLUETOOTH). Once client device 800 is paired with a wireless transceiver 303, a push notification can be sent to client device 800 with instructions to install customer application 902. In the alternative, server 1200 can issue an alert or message to cause a sales person to approach the person operating client device 800 and eventually instruct the person to install customer application 902 on client device 800 (as described below with reference to FIG. 18). Once client device 800 installs customer application 902, that device will then become client device 800 (customer).

Once installed, customer application 902 will cause client device 800 (customer) to automatically communicate with any module 201 when client device 800 (customer) enters wireless footprint 500 for that module. That communication will include client device 800 (customer) sending unique identifier 1501 to any module 201 with which it is communicating. Unique identifier 1501 is an identification number or code that uniquely identifies client device 800 (customer), such as a UUID (universally unique identifier) or GUID (globally unique identifier) that are known in the prior art. Optionally, client device 800 (customer) can send its GPS or GNSS coordinates obtained by positioning unit 804 (e.g., latitude data and longitude data) to module 201.

Module 201 then will send unique identifier 1501 to server 1200 and optionally will send GPS or GNSS coordinates. Thereafter, client device 800 (customer) will periodically re-send its unique identifier and optionally its GPS or GNSS data to any module 201 in whose footprint client device 800 (customer) resides at the time.

In addition, with reference to each of FIGS. 14-17, wireless transceivers 202 will periodically send unique identifier 1501 and other information using wireless transceiver 601 to any gateway 203 and module 201 whose wireless footprint 500 wireless transceiver 201 resides within and which is in range of wireless footprint 700 of the wireless transceiver 201.

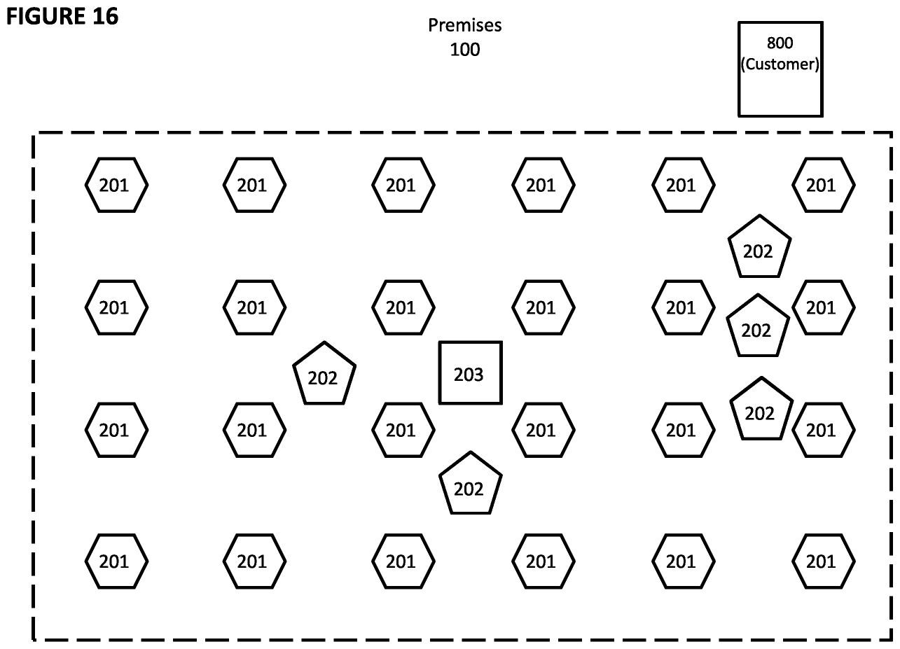

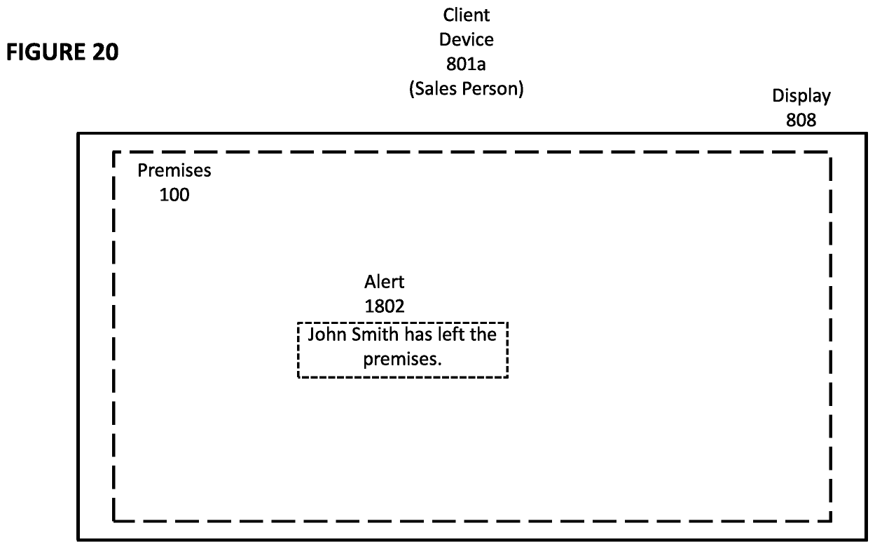

With reference to FIG. 16, if a certain amount of time, T, elapses with client device 800 (customer) not sending its unique identifier to any module 201, then server 1200 can deduce that client device 800 (customer) is no longer within wireless footprint 500 of any module 201, meaning that client device 800 (customer) is likely outside of premises 100. Server 1200 at that point can send an alert to any client device 800 (sales person) that had been in contact with client device 800 (customer) so that the sales person operating client device 800 (sales person) will know that the customer has left the premises (as shown in FIG. 20, below). Unlike in the prior art, the sales person will not waste any time physically looking for the customer who is no longer on the premises. The sales person can them move onto other business or can communicate directly with client device 800 (customer), such as by sending an email, text message, or a message facilitated by customer application 902, sales person application 1002, and/or client application 1302, or by initiating a voice call over the cellular network or through other mechanisms.

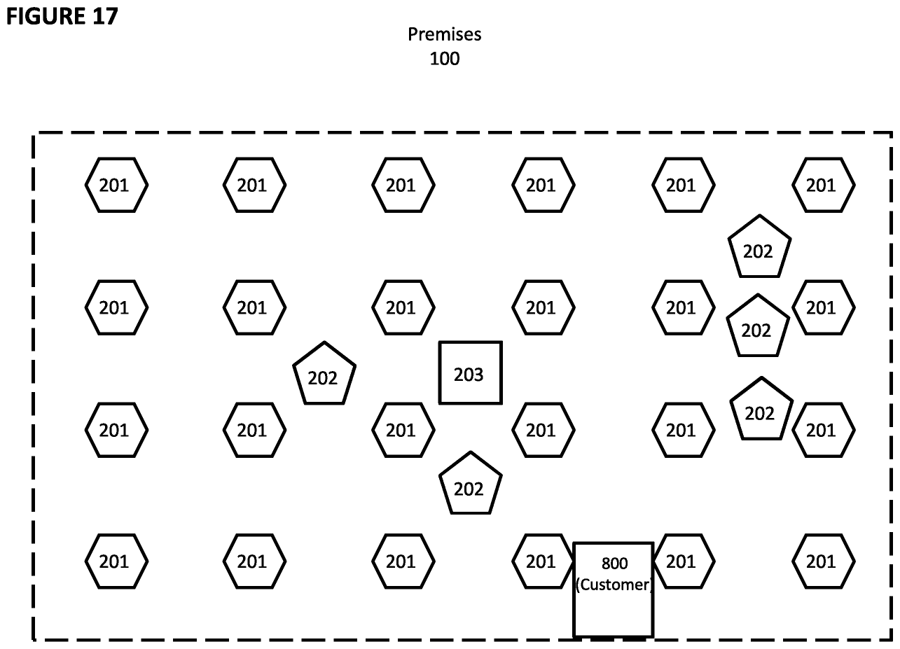

With reference to FIG. 17, if client device 800 (customer) is subsequently detected by any module 201, then server 1200 will immediately be informed that the customer has returned to premises 100, and the appropriate client device 800 (sales person) can be informed. This also will prevent the inefficiencies of the prior art where other sales persons would speak with the customer only to find out that the customer has already been assigned to a specific sales person.

FIGS. 18-21 depict exemplary graphical images displayed on client device 800 (sales person) during the events described in FIGS. 14-17. These images that can be generated on display 808 on client device 800 (sales person) by sales person application 1002.

With reference to FIG. 18, sales person application 1002 generates a graphical depiction of premises 100 on display 808. When the unknown person is detected in the scenario of FIG. 14, server 1200 causes sales person application 1002 to generate icon 1801 to represent an unknown person. Optionally, sales person application 1002 generates alert 1802, such as the text, “An unknown person has entered the premises.” The sales person operating client device 800 (sales person) then will know that an unknown person has entered premises 100 and can approach that person if appropriate under the understood protocol followed by the sales persons and/or can be assigned by server 1200 to approach the unknown person. In the latter case, alert 1802 might also include the text, “Sales Person X, please approach the unknown person. Please assist the person in installing customer application 902.”

When the person installs customer application 902, he or she will input information that can be useful to the functionality described herein, such as a photo of the person's driver's license, credit card information, and insurance information.

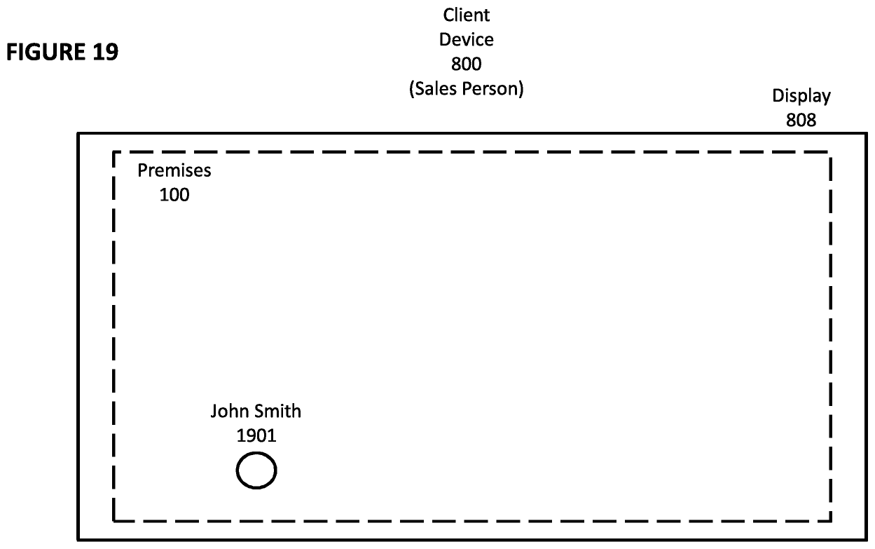

With reference to FIG. 19, after client device 800 (customer) installs customer application 902 as in the scenario of FIG. 15, server 1200 will cause sales person application 1002 to display icon 1901 to represent the now known person (e.g., John Smith) based on the information entered by the person in configuring customer application 902. Icon 1901 will be located within the graphical depiction of premises 100 in a manner corresponding the actual location of client device 800 (customer) within premises 100. The location information can be determined using the GPS and GNSS data collected from client device 800 (customer) or can be based on the relative location of the module(s) 201 in whose wireless footprint 500 client device 800 (customer) currently resides.

With reference to FIG. 20, when client device 800 (customer) is no longer detected by modules 201 after a certain period of time, T, as in the scenario of FIG. 16, server 1200 causes sales person application 1002 to display alert 1802, such as the text, “John Smith has left the premises.”

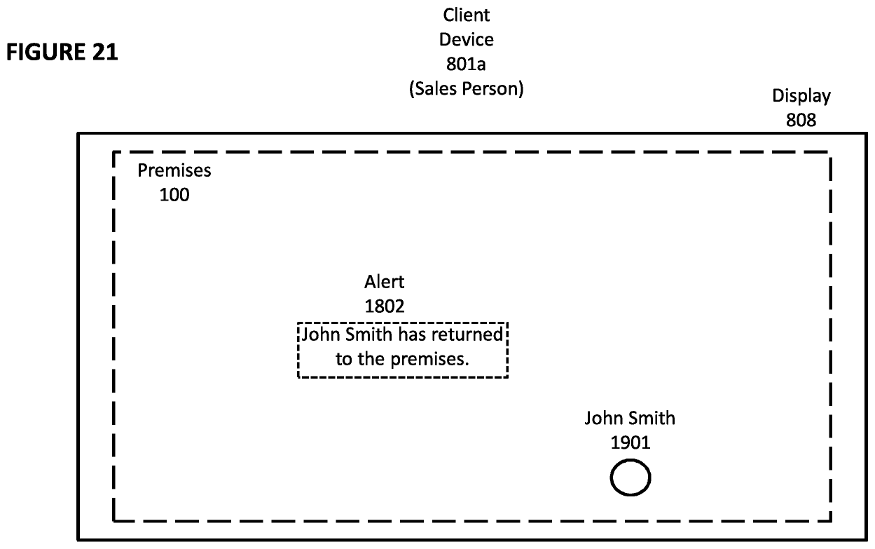

With reference to FIG. 21, when client device 800 (customer) returns to premises 100 as in the scenario of FIG. 17, server 1200 causes sales person application 1002 to display icon 1901 for John Smith in the appropriate location on display 808 and to display alert 1802, such as the text, “John Smith has returned to the premises.”

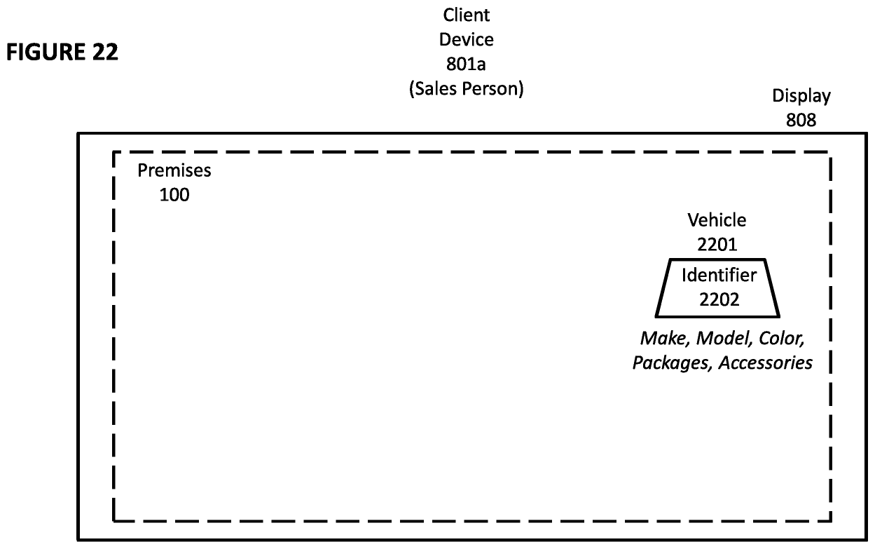

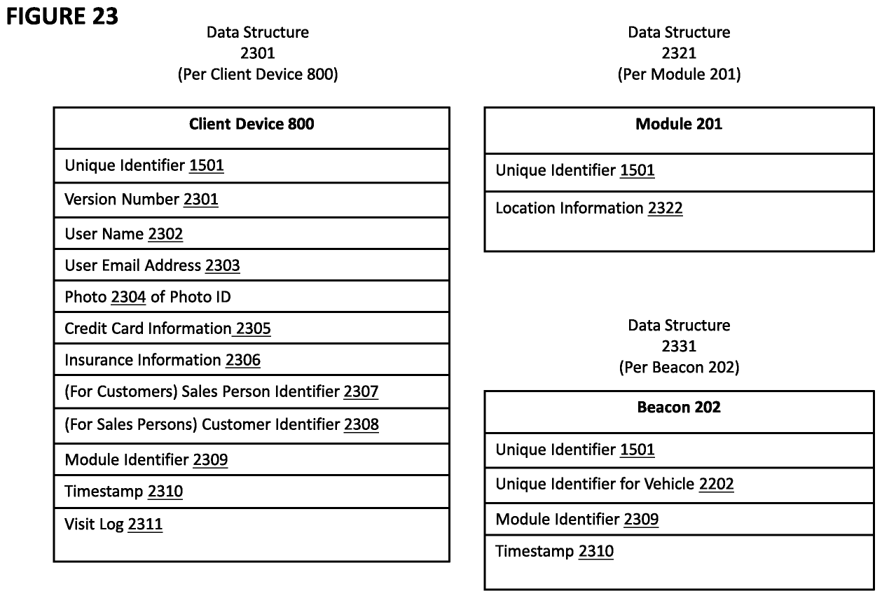

With reference to FIG. 22, if the sales person wishes to physically locate a particular vehicle, he or she can enter an identifier 2202 for the vehicle (such as a VIN number known in the prior art), and server 1200 can cause sales person application 1002 to display icon 2201 to indicate the physical location of the vehicle within premises 100 and can optionally display the identifier 2202 (e.g., VIN number) and other information (e.g., make, model, color, packages, accessories, etc.) for that vehicle. Optionally, identifier 2202 can be unique identifier 1501 for the wireless transceiver 202 that had been placed in the vehicle. Or, if identifier 2202 is different than unique identifier 1501, server 1200 can determine the particular wireless transceiver 202 that is associated with that particular identifier 2202 (such as by referring to data structure 2302, discussed below with reference to FIG. 23) and can then display the location of the vehicle based on the location of wireless transceiver 202. The location of wireless transceiver 202 is known based on the relative location of the module(s) 201 in whose wireless footprint 500 wireless transceiver 202 currently resides.

With reference to FIG. 23, server 1200 can collect and store information regarding each customer who installs customer application 902, each sales person who installs sales person application 1002, and each vehicle in which a wireless transceiver 202 is placed. This information can be stored in data store 1201. For example, data structure 2301 can be created for each client device 800, data structure 2311 can be created for each module 201, and data structure 2321 can be created for each wireless transceiver 202. Data structures 2301, 2311, and 2321 can each comprise, for example, a table in a SQL database.

In the examples shown in FIG. 23, data structure 2301 is created for each client device 800 (customer or sales person) and comprises fields containing the following types of data:
unique identifier 1501;
version number 2301, which is the version number of customer application 902 or sales person application 1002 installed on client device 800;
user name 2302, which is the name of the customer or sales person operating client device 800;
user email address 2303;
photo 2304 of user's photo ID (such as a driver's license);
credit card information 2305;
insurance information 2306;
if the operator of client device 800 is a customer, an identifier 2307 for the sales person(s) who has been assigned to that customer, which can be a name or identifier for the sales person(s) or can be the unique identifier 1501 for the client device 800 (sales person) operated by that sales person;
if the operator of client device 800 is a sales person, an identifier 2308 for the customer(s) who have been assigned to that sales person, which can be a name or identifier for the customer or can be the unique identifier 1501 for the client device 800 (customer) operated by that customer;
module identifier 2309, which is a unique identifier (such as unique identifier 1501) for module(s) 201 in whose wireless footprint 500 client device 800 currently resides or most recently resided;
timestamp 2310, which is the date and time of the last communication received by such module(s) 201 from client device 800; and
visit log 2311, which contains data and time information for all visits made to premises 100 by client device 800, which might comprise a log of all timestamps 2306 recorded for client device 800.

Data structure 2321 is created for each module 201 and comprises fields containing the following types of data:
unique identifier 1501; and
location information 2322, which is information that specifies the relative location of module 201 within premises 100. This is essential so that the location of client devices 800 and wireless transceivers 202 can be determined through their communications with modules 201. One option is for an installer to manually enter location information (which can be absolute longitude and latitude data, relative location data based on the configuration and layout of premises 100, or other information from which the relative location can be determined) into server 1200 for each module 201 at the time the module 201 is installed in premises 100. Another option is to use another computing device (for example, a client device 800 operated by the installed) containing positioning unit 804 to determine the GPS or GNSS coordinates of the module 201 at the time the module 201 is installed.

Data structure 2331 is created for each wireless transceiver 202 and comprises fields containing the following types of data:
unique identifier 1501;
unique identifier for vehicle 2202, which can be the VIN number for the vehicle in which wireless transceiver 202 is placed;
module identifier 2309, which is a unique identifier (such as unique identifier 1501) for module(s) 201 in whose wireless footprint 500 wireless transceiver 202 currently resides or most recently resided; and
timestamp 2310, which is the date and time of the last communication received by such module(s) 201 from wireless transceiver 202.

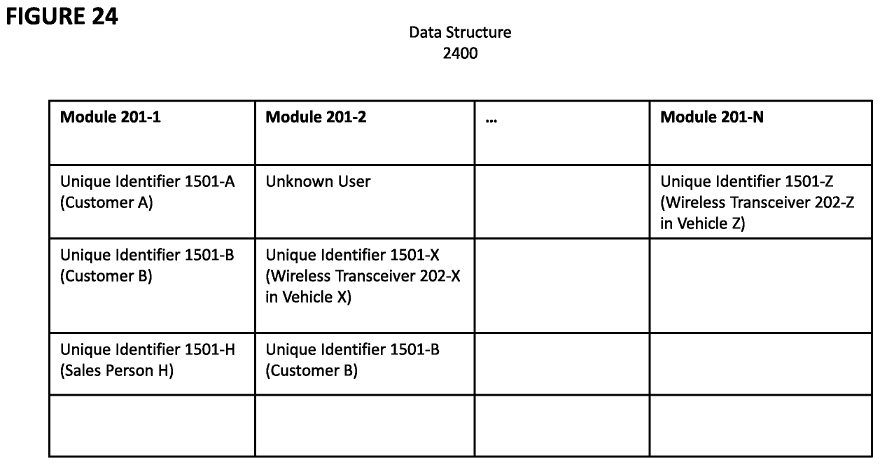

With reference to FIG. 24, server 1200 can collect and store real-time information regarding the status of each module 201. This information can be stored in data store 1201. For example, data structure 2400 and can comprise, for example, a table in a SQL database or data maintained in memory 802 of server 1200.

In example shown in FIG. 24, it is assumed that there are N modules 201 installed in premises 100, which are labeled module 201-1 through module 201-N. For each module 201, data structure 2400 indicates:
Unique identifiers 1501 for all client devices 800 within the wireless footprint 500 of the module 201;
The presence of any unknown persons within the occupancy footprint 400 of the module 201; and
Unique identifiers 1501 for all wireless transceivers 202 (or the unique identifiers for all vehicles 2202) within the wireless footprint 500 of each module.

In this instance, unique identifiers 1501-A, 1501-B, and 1501-H (corresponding to client devices 800 operated by customer A, customer B, and sales person H, respectively) are within the wireless footprint 500 of module 201-1. An unknown user and unique identifiers 1501-X and 1501-B (corresponding to wireless transceiver 202-X in vehicle X and client device 800 operated by customer B, respectively) are within the wireless footprint 500 of module 201-2. Unique identifier 1501-Z (corresponding to wireless transceiver 202-Z in vehicle Z) is within the wireless footprint 500 of module 201-N. It should be noted that unique identifier 1501-B is shown for both modules 201-1 and 201-2 because in this particular instance, client device 800 with unique identifier 1501-B is within wireless footprint 500 of both modules 201-1 and 201-2 (and those modules also within the wireless footprint of client device 800).

It is to be further understood that server 1200 will have access to other data typically available to prior art car dealerships, such as configuration information for each vehicle or credit report information for each particular customer, and server 1200 will be able to collect and that information according to each particular vehicle identifier 2202 or unique identifier 1501 and provide that information to client devices 800.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A system for monitoring a premises, comprising:
a plurality of modules, each of the plurality of modules comprising an occupancy sensor and a wireless transceiver;
a wireless gateway for communicating with one or more of the plurality of modules; and
a server coupled to the wireless gateway, wherein the server is configured to instruct a wireless transceiver in a first module to locate a computing device within a wireless footprint of the first module when the occupancy sensor in the first module detects a person within an occupancy footprint of the first module.

2. The system of claim 1, wherein the system further comprises:
one or more wireless transceivers separate from the one or more modules, wherein the one or more wireless transceivers can communicate with the wireless gateway.

3. The system of claim 1, wherein the server is further configured to obtain a device identifier for the computing device when the computing device is located.

4. The system of claim 1, wherein each of the plurality of modules further comprises a lighting device.

5. The system of claim 1, wherein the wireless transceiver in each module is capable of communicating with a computing device using a first wireless protocol and with the wireless gateway using a second wireless protocol.

6. The system of claim 1, wherein each of the plurality of modules receives power from an alternating current power grid.

7. The system of claim 1, wherein each of the plurality of modules receives power from a solar cell array.

8. The system of claim 1, wherein each of the plurality of receives power from a battery.

9. The system of claim 1, further comprising:
a client device for generating a user interface depicting the premises and the relative location of the detected person.

10. A method of detecting the entrance of a person within a premises, comprising:
monitoring, by a plurality of modules, the premises, wherein each module comprises an occupancy sensor and a wireless transceiver;
detecting, by an occupancy sensor in one of the plurality of modules, a person within the premises;
attempting to obtain a device identifier for a computing device in proximity to the person; and
when no device identifier is obtained, generating an alert.

11. The method of claim 10, wherein the alert is a textual alert generated by a server on a client device.

12. The method of claim 10, further comprising:
registering, by a server, a computing device for the person.

13. The method of claim 10, wherein the registering step comprises:
storing a device identifier for the computing device; and
storing identification information for the person.

14. A method of detecting the departure of a person from a premises, comprising:
monitoring, by a plurality of modules, the premises, wherein each module comprises an occupancy sensor and a wireless transceiver;
detecting, by an occupancy sensor in one of the plurality of modules, a person on the premises;
identifying a device identifier for a computing device in proximity to the person; and
after a pre-determined time interval in which the computing device does not communicate with any of the plurality of modules, generating an alert indicating the person has left the premises.

15. The method of claim 14, wherein the alert is a textual alert generated by a server on a client device.

16. The method of claim 14, further comprising:
detecting, by an occupancy sensor in one of the plurality of modules, a person on the premises;
identifying a device identifier for the computing device in proximity to the person; and
generating an alert indicating the person has returned to the premises.

17. The method of claim 16, wherein the alert is a textual alert generated by a server on a client device.

18. The method of claim 14, further comprising:
generating, on a client device, a user interface depicting the premises and the relative location of the person.

19. A method of identifying a location of a physical asset within a premises, comprising:
coupling a first wireless transceiver to a first physical asset;
monitoring, by a plurality of modules, the premises, wherein each module comprises an occupancy sensor and a wireless transceiver;
identifying, by one of the plurality of modules, a device identifier for the first wireless transceiver;
determining a location for the first wireless transceiver; and
generating, on a client device, a user interface depicting the premises and the relative location of the first physical asset.

20. The method of claim 19, wherein the location for the first wireless transceiver is determined based on the location of the module that identified the device identifier for the first wireless transceiver.

21. The method of claim 19, wherein the physical asset is a vehicle.

22. The method of claim 19, wherein the physical asset is a vehicle key.
